(19) United States
(12) Patent Application Publication
(10) Pub. No.: US 2007/0018777 A1
(43) Pub. Date: Jan. 25, 2007

(54) PTC rod assembly and pre-heater including the same

(76) Inventor: Hyo Lee Seock, Cheonan-city (KR)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/485,897

(22) Filed: Jul. 13, 2006

(30) Foreign Application Priority Data
Jul. 15, 2005 (KR) 10-2005-64386
Sep. 28, 2005 (KR) 10-2005-90460

(51) Int. Cl. H01C 7/13

(52) U.S. Cl. 338/22 R

(57) ABSTRACT

A positive temperature coefficient (PTC) rod assembly including an electrode terminal, an insulator, first and second supporting members on both surfaces of the electrode terminals at through holes, PTC elements and heat transfer blocks coupled between adjacent pairs of the first supporting members and between adjacent pairs of the second supporting members, respectively, and in contact with the electrode terminal, and first and second PTC rods. The electrode terminal has a plurality of pairs of through-holes at a predetermined interval in a longitudinal direction, with the through-holes of each pair spaced apart vertically from each other. The insulator coupling members are longitudinally coupled to upper and lower ends of the electrode terminal. The pairs of supporting members are connected to each other through the through-holes. The first PTC rod defines a channel with a predetermined length to accommodate the electrode terminal, the insulator, the PTC elements and the heat transfer blocks. The second PTC rod has a length identical with that of the first PTC rod and is coupled to the first PTC rod to cover an open portion of the first PTC rod. A vehicle pre-heater includes a plurality of the PTC rod assemblies, with heat radiation fin assemblies in close contact with both surfaces of each of the PTC rod assemblies. A pair of frames are coupled to outer side surfaces of the outermost heat radiation fin assemblies, and first and second housings are coupled to both longitudinal ends of a combination of the PTC rod assemblies, the heat radiation fin assemblies and the frames. Terminals in the housings serve as cathode terminals.

### CROSS REFERENCE TO RELATED APPLICATION(S)

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates to a positive temperature coefficient (“PTC”) rod assembly and a pre-heater for a vehicle including the same

### BACKGROUND OF THE INVENTION AND TECHNICAL PROBLEMS POSED BY THE PRIOR ART

A general vehicle has a heating apparatus for heating the interior of the vehicle or removing moisture or frost on a windshield of the vehicle using thermal energy of cooling water heated by heat generated from an engine of the vehicle.

In the heating apparatus, since the cooling water (which flows around the engine after the engine is started) is introduced into a heater, it takes a great deal of time to heat the cooling water and to subsequently heat the interior of the vehicle. Accordingly, there is a problem in that a driver and/or passenger(s) may be required to stay in the cold interior of the vehicle for a certain period of time after the engine is started.

To solve such a problem, Korean Laid-Open Patent Publication No. 10-2004-0089570 discloses an apparatus for accommodating ceramic heating elements such as PTC elements. Further, to solve the above problem, a heat rod assembly and a pre-heater for a vehicle including the same (Korean Patent Application No. 10-2004-0031176) has been proposed.

FIG. 1 is a perspective view of an electrode terminal and an insulator employed in a conventional prior art apparatus for accommodating PTC elements, and FIG. 2 is a sectional view of a conventional prior art apparatus for accommodating the PTC elements. As shown in FIGS. 1 and 2, the conventional apparatus for accommodating the PTC elements comprises an insulator 30 made of an electrically insulative material, and an electrode terminal 32 embedded in and coupled to the insulator 30.

The insulator 30 is provided with recesses 34 in which the PTC elements 36 are seated to come into contact with the electrode terminal 32, and supports 38 formed longitudinally at both side ends thereof. A longitudinal groove 40 is formed in an inner surface of each of the supports 38, and a portion of the electrode terminal 32 on the side of a terminal lug 42 thereof is completely surrounded by an insulator sheath 44. The supports 38 are connected to each other by transverse ribs 46 spaced apart from one another by a certain distance in the longitudinal direction and disposed in parallel to one another. A plurality of studs 48 are provided on inner side surfaces of the supports 38 and the traverse ribs 46.

When the PTC elements 36 are seated in the recesses 34, the studs 48 are pressed against side surfaces of the PTC elements 36 to fix the PTC elements 36. Hooks 50 protruding in lateral opposite directions are formed at a side of the insulator 30 opposite to the insulator sheath 44 so that the insulator 30 can be fixed to a heating device, and the insulator is introduced into a profile tube 52. At this time, to prevent the electrode terminal 32 from coming into contact with the profile tube 52, an insulative strip 54 is coupled to a side surface of the contact plate opposite to a side surface with which the PTC elements 36 are in contact.

In the conventional apparatus for accommodating the PTC elements constructed as above, since the insulator 30 and the electrode terminal plate 32 are coupled to each other by a friction force therebetween, there is a risk of release of the coupling of the insulator 30 with the electrode terminal 32. Further, there is a disadvantage in that a failure may occur due to introduction of dust or other foreign substances into a space between the insulator 30 and the profile tube 52.

Moreover, the conventional apparatus for accommodating the PTC elements has a structure by which gas generated at the time of heating of the PTC elements cannot be discharged to the outside. In this structure, if gas is generated, a gap between the insulator 30 and the electrode terminal 32 widens to form a certain space, and gas is discharged through this space, generating a noise during gas discharge through the space.

Further, since the PTC elements 36 are coupled to only one side of the electrode terminal 32 in the conventional apparatus for accommodating the PTC elements, there is a problem in that heat cannot be transferred uniformly.

The present invention is directed toward overcoming one or more of the problems set forth above.

### SUMMARY OF THE INVENTION

In one aspect of the present invention, a positive temperature coefficient (PTC) rod assembly is provided, including an electrode terminal, an insulator including a pair of coupling members, first and second supporting members on both surfaces of the electrode terminals at the through holes, PTC elements and heat transfer blocks coupled between adjacent pairs of the first supporting members and between adjacent pairs of the second supporting members, respectively, and in contact with the electrode terminal, and first and second PTC rods. The electrode terminal has a plurality of pairs of through-holes at a predetermined interval in a longitudinal direction, with the through-holes of each pair spaced apart vertically from each other. The insulator coupling members are longitudinally coupled to upper and lower ends of the electrode terminal. The pairs of supporting members are connected to each other through the through-holes. The first PTC rod defines a channel with a predetermined length to accommodate the electrode terminal, the insulator, the PTC elements and the heat transfer blocks, and the second PTC rod has a length identical with that of the first PTC rod and is coupled to the first PTC rod to cover an open portion of the first PTC rod.

In one form of this aspect of the present invention, the insulator has enlarged portions formed at both ends thereof in close contact with and coupled to outer surfaces of both longitudinal ends of each of the first and second PTC rods. In a further form, at least one of the enlarged portions has an open face through which one side surface of the electrode terminal is exposed, and in a still further form the electrode terminal has a fixing hole contacting the at least one enlarged portion, and the enlarged portion has a fixing protrusion passing through the fixing hole. In another further form, one of the pair of enlarged portions has a passage.

In another form of this aspect of the present invention, the insulator is formed integrally with the electrode terminal through a dual injection molding process.

In still another form of this aspect of the present invention, the insulator is coupled to the electrode terminal by detachable coupling structures of the first and second supporting members.

In yet another form of this aspect of the present invention, the pair of coupling members include a step whereby the width of a portion on which the PTC element is placed is different from that of a portion on which the heat transfer block is placed. In a further form, the width of the portion of the pair of coupling members on which the PTC element is placed is larger than that of the portion on which the heat transfer block is placed.

In another form of this aspect of the present invention, the electrode terminal has one end protruding outside of the enlarged portion and folded in two plies. In a further form, the terminal is bent in the shape of a crank.

In still another form of this aspect of the present invention, one of the first and second supporting members has passages at both ends thereof, and the other of the first and second supporting members has a passage at an intermediate portion thereof.

In yet another form of this aspect of the present invention, the electrode terminal through-holes are elongated.

In another aspect of the present invention, a pre-heater for a vehicle is provided, including a plurality of PTC rod assemblies as described above and arranged in parallel to one another, with one or more heat radiation fin assemblies in close contact with both surfaces of each of the PTC rod assemblies. A pair of frames are coupled to outer side surfaces of the outermost heat radiation fin assemblies, and a first housing and a second housing are coupled to both longitudinal ends of a combination of the PTC rod assemblies, the heat radiation fin assemblies and the frames. Housing terminals are provided in the housings and serving as cathode terminals.

In one form of this aspect of the present invention, each of the outermost PTC rod assemblies has PTC elements mounted on a surface thereof facing the interior of the pre-heater.

In another form of this aspect of the present invention, at least one of the PTC assemblies has the PTC elements and the heat transfer blocks alternatively mounted to both side surfaces thereof.

In still another form of this aspect of the present invention, the number of the heat radiation fin assemblies coupled to a side of each of the PTC rod assemblies where the PTC elements are mounted is larger than that of the heat radiation fin assemblies coupled to the other side of the PTC rod assembly where a PTC element is not mounted.

In yet another form of this aspect of the present invention, each of the frames has an elongated, reinforcing groove formed on a surface thereof brought into contact with the heat radiation fin assembly in a longitudinal direction of the contact surface with the heat radiation fin assembly.

In still another form of this aspect of the present invention, an intermediate portion of a surface of each of the frames contacts and slantly protrudes toward the corresponding heat radiation fin assembly.

In yet another form of this aspect of the present invention, each of the housing terminals includes a bent plate contacting one end of the PTC rod.

### BRIEF DESCRIPTION OF THE DRAWINGS

FIG. 1 is a perspective view of an electrode terminal and an insulator that are employed in a conventional apparatus for accommodating PTC elements;

FIG. 2 is a sectional view of the conventional apparatus for accommodating the PTC elements;

FIG. 3 is an exploded perspective view of a PTC rod assembly according to a first embodiment of the present invention;

FIGS. 4 to 6 are perspective views sequentially showing processes of manufacturing a terminal of an electrode terminal included in the first embodiment;

FIG. 7 is a perspective view showing one side surface of a combination of the electrode terminal and an insulator included in the first embodiment;

FIG. 8 is a perspective view showing the other side surface of the combination of the electrode terminal and the insulator included in the first embodiment;

FIG. 9 is a sectional view of the electrode terminal and the insulator taken along line A-A in FIG. 4;

FIG. 10 is a sectional view of the electrode terminal and the insulator taken along line B-B in FIG. 4;

FIG. 11 is an exploded perspective view of a PTC rod assembly according to a second embodiment of the present invention;

FIG. 12 is a perspective view showing one side surface of a combination of an electrode terminal and an insulator included in the second embodiment;

FIG. 13 is a perspective view showing the other side surface of the combination of the electrode terminal and the insulator included in the second embodiment;

FIG. 14 is an exploded perspective view showing an electrode terminal and an insulator of a PTC rod assembly according to a third embodiment of the present invention;

FIG. 15 is an exploded perspective view of a pre-heater for a vehicle according to the present invention;

FIGS. 16 to 18 are exploded views showing the coupling positions of PTC elements and heat transfer blocks in respective PTC rod assemblies included in the pre-heater for a vehicle according to the present invention;

FIG. 19 is a view showing a coupled state of a first housing and the PTC rod assemblies included in the pre-heater for a vehicle according to the present invention;

FIG. 20 is a sectional perspective view of the housing employed in the pre-heater according to the present invention; and

FIG. 21 is a sectional view of the housing, showing a coupling structure of one of housing terminals.

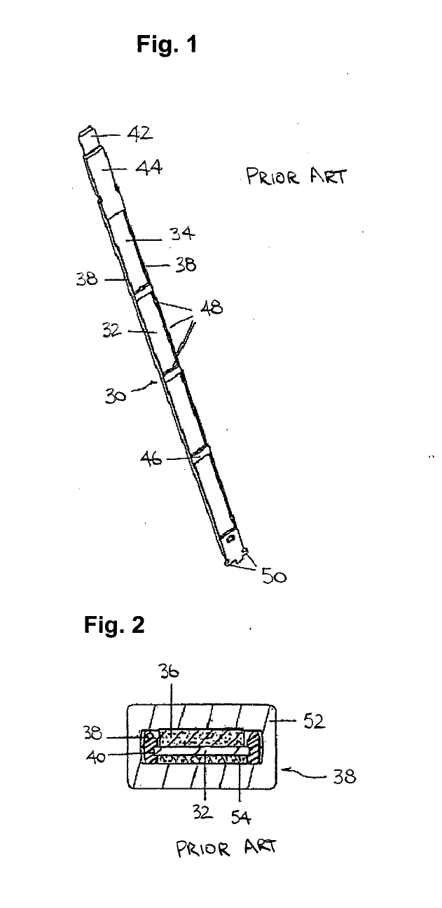

### DETAILED DESCRIPTION OF THE INVENTION

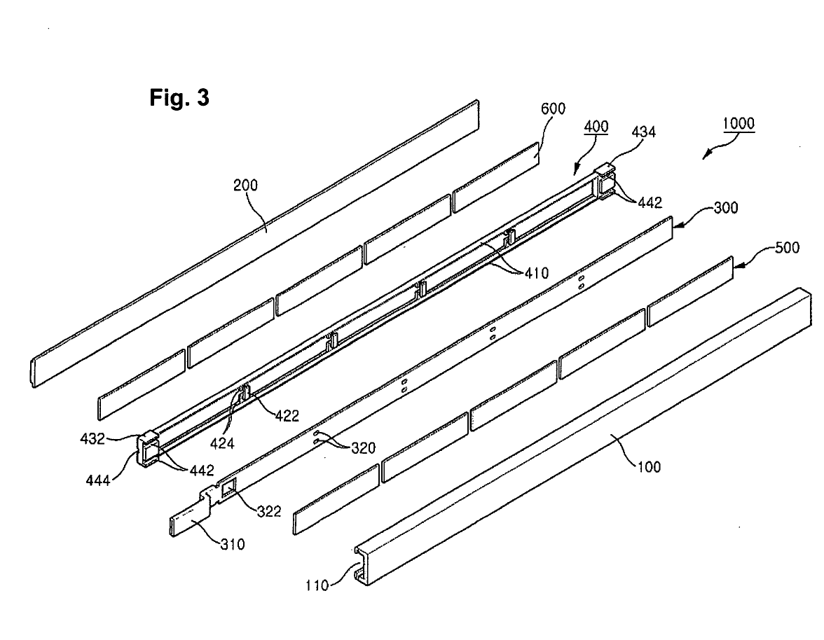

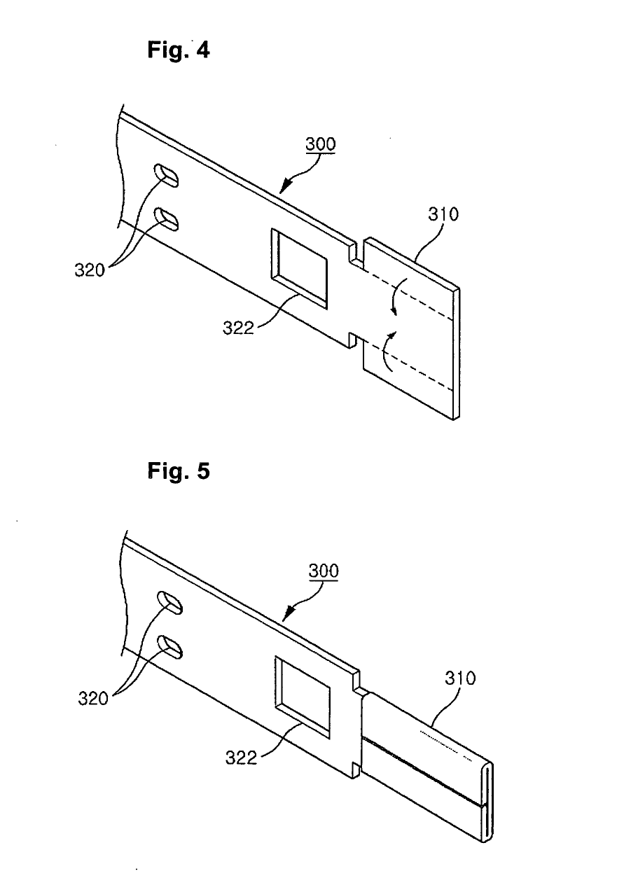

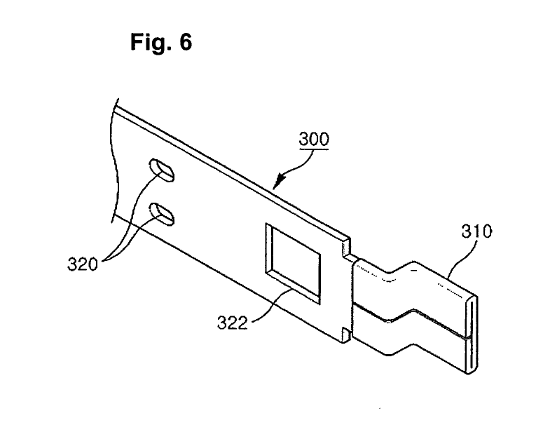

FIG. 3 is an exploded perspective view of a PTC rod assembly 1000 according to a first embodiment of the present invention, and FIGS. 4 to 6 are perspective views sequentially showing processes of manufacturing a terminal of an electrode terminal included in the first embodiment.

As shown in FIG. 3, the PTC rod assembly 1000 according to the first embodiment of the present invention comprises a first PTC rod 100 constructed in the form of a channel in cross section and having a predetermined length, and a second PTC rod 200 having the same length as the first PTC rod 100 and coupled to the first PTC rod 100 so as to cover an open portion of the first PTC rod.

At this time, when the first and second PTC rods 100 and 200 are coupled to each other, a space 110 having a rectangular cross section is provided therebetween, and an electrode terminal 300, an insulator 400, PTC elements 500 and heat transfer blocks 600 are accommodated in the space 110.

The electrode terminal 300 has a length longer than those of the first and second PTC rods 100 and 200. A terminal 310 is formed at a leading end of the electrode terminal, and through-holes 320 are formed at a predetermined interval in the electrode terminal. The terminal 310 is bent in the form of a crank and protrudes outside of leading ends of the first and second PTC rods 100 and 200. The width of the leading end of the electrode terminal 300 where the terminal 310 is formed is larger than that of an intermediate portion of the electrode terminal.

As shown in FIGS. 4 to 6, upper and lower sides of the leading end of the electrode terminal are folded inward, and the folded end of the electrode terminal is then bent in the form of a crank to form the terminal 310.

The thickness of the terminal 310 constructed as above is twice as large as that of the intermediate portion of the electrode terminal 300, so that the strength of the terminal 310 can be increased. Accordingly, there is an advantage in that the terminal can more stably transmit an electric current in a state where the terminal is connected to a connector or housing.

The through-holes 320 formed in the electrode terminal 300 are used for fixing the insulator 400 to the electrode terminal 300 through a double injection molding process, with two through-holes vertically spaced apart from each other in a pair, and a plurality of pairs of through-holes arranged at the predetermined interval in the longitudinal direction of the electrode terminal 300. Further, the through-holes 320 may be provided in the form of an elongated hole to increase a coupling force between the electrode terminal 300 and the insulator 400 and to facilitate injection and flow of an injection molding material when a dual injection molding process is carried out.

Among the through-holes 320, one through-hole 322 formed on the side of the terminal 310 is provided in the form of a quadrangle different from the shape of the other through-holes. This through-hole 322 is to maximize a coupling force between the electrode terminal 300 and the insulator 400.

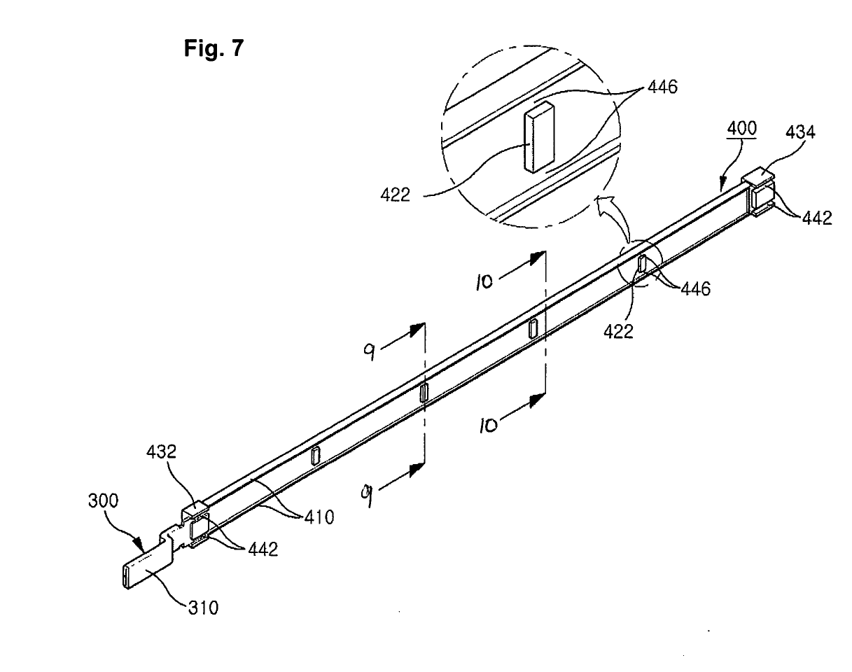

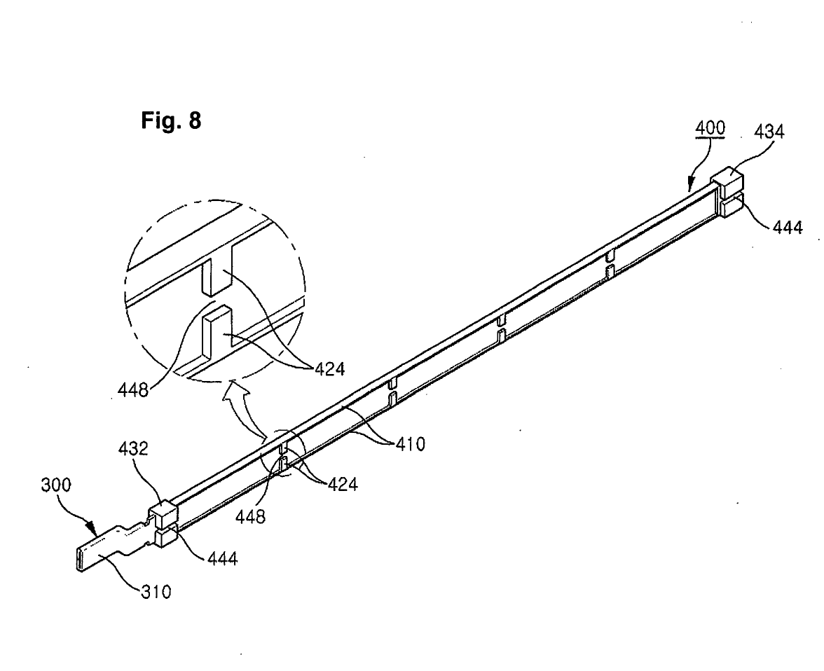

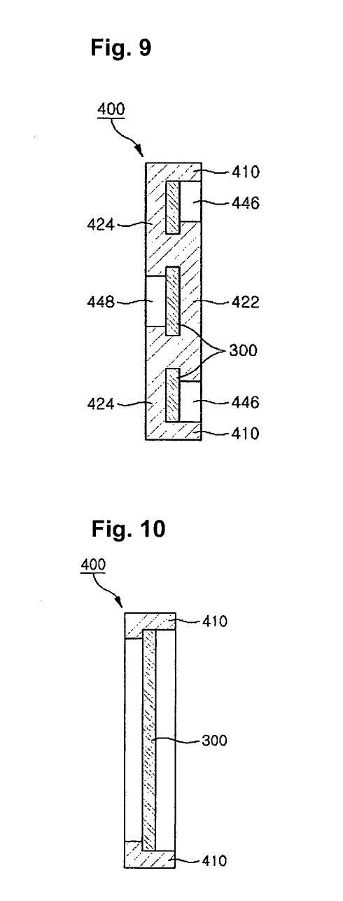

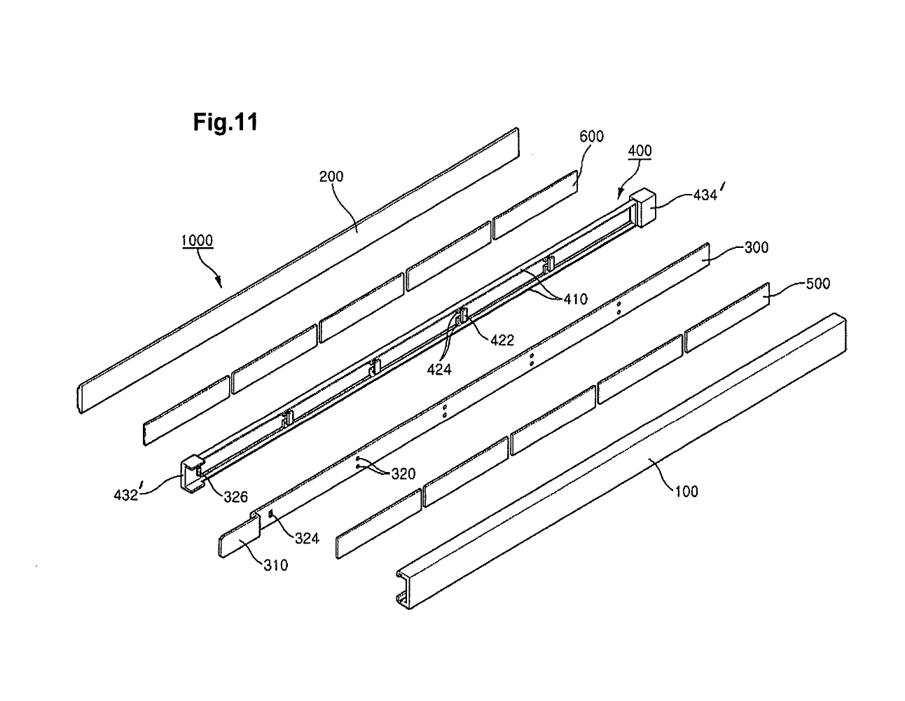

FIG. 7 illustrates one side surface of a combination of the electrode terminal and an insulator included in the first embodiment, and FIG. 8 illustrates the other side surface of the combination of the electrode terminal and the insulator included in the first embodiment. FIGS. 9 and 10 are sectional views of the electrode terminal and the insulator taken along lines 9-9 and 10-10 in FIG. 7, respectively. As shown in these figures, the insulator 400 is used to prevent the electrode terminal 300 from being in contact with the first and second PTC rods 100 and 200 and dust and other foreign substances from being introduced into the space 110 formed by coupling the first and second PTC rods 100 and 200.

The insulator 400 comprises a pair of coupling members 410 longitudinally coupled to upper and lower ends of the electrode terminal 300, and first and second supporting members 422 and 424 placed at locations on both surfaces of the electrode terminal 300 where the pairs of through-holes 320 are formed. The first and second supporting members 422 and 424 are connected to each other through the pair of through-holes 320.

As described above, the insulator 400 is coupled to the electrode terminal 300 through the dual injection molding process, and enlarged portions 432 and 434 are formed at both longitudinal ends of the insulator 400, respectively. The pair of enlarged portions 432 and 434 are brought into close contact with and coupled to outer surfaces of both longitudinal ends of each of the first and second PTC rods 100 and 200 to guide the coupling positions of the first and second PTC rods 100 and 200. Accordingly, the electrode terminal 300 is coupled to the first and second PTC rods 100 and 200 such that the electrode terminal is spaced apart by certain distances from inner surfaces of the first and second PTC rods, with passages 442 and 444 provided on both surfaces of each of the enlarged portions 432 and 434 as described in greater detail below.

A plurality of first and second supporting members 422 and 424 are formed at a predetermined interval in the longitudinal direction of the electrode terminal 300. The distance between adjacent supporting members 422 and 424 is identical with the distance between the paired through-holes 320. That is, the first and second supporting members 422 and 424 are formed at locations corresponding to the through-holes 320.

At this time, passages 446 are formed near upper and lower ends of the first supporting member 422, and a passage 448 is formed between the paired second supporting members 424. In other words, the first supporting member 422 is formed such that the upper and lower ends of the first supporting member are spaced apart from the respective coupling members 410, and thus, the passages 446 are provided between the upper and lower ends of the first supporting member and the coupling members. The second support members 424 are formed to extend vertically from the coupling members 410 and the passage 448 is provided between the paired second support members. The passages 446 and 448 provided at the first and second supporting members 422 and 424 are described below.

Accordingly, a coupling state between the insulator 400 and the electrode terminal 300 is not released unless the portions of the insulator penetrating through the through-holes 320 are broken. Further, since the first supporting member 422 and the pair of supporting members 424 are coupled to one another through the elongated through-hole 320, there are advantages in that it is easy to inject an injection molding material, and the supporting members can have lengths smaller than those of conventional supporting members and thus be injection-molded in accurate shapes.

The PTC elements 500 and the heat transfer blocks 600 are coupled to both surfaces of the insulator 400, that is, between adjacent first supporting members 422 and between adjacent pairs of second supporting members 424, respectively. The PTC elements 500 and the heat transfer blocks 600 are coupled to be in contact with the electrode terminal 300.

In order to prevent the coupling positions of the PTC elements 500 and the heat transfer blocks 600 from being interchanged with each other, the coupling members 410 are formed such that the vertical widths of exposed portions of the both surfaces of the electrode terminal 300 are different from each other. In other words, the width of a portion on which the PTC element 500 is to be placed is different from the width of a portion on which the heat transfer blocks 600 is to be placed. Accordingly, there is no case where the coupling positions of the PTC elements 500 and the heat transfer blocks 600 are inadvertently (and incorrectly) interchanged with each other. In this embodiment, as shown in FIG. 10, a step is formed on an inner surface of the insulator 400 such that the width of an exposed portion of the electrode terminal in one surface of the insulator 400 where the heat transfer block 600 is to be placed is smaller than the width of an exposed portion of the electrode terminal in the other surface of the insulator. However, this is merely for illustrative purposes, and a reverse configuration may be formed according to user's selection.

The passages 442-448 provided at the enlarged portions 432 and 434 and the first and second supporting members 422 and 424 of the insulator 400 constructed as above are to discharge gas generated from the electrode terminal 300, the PTC elements 500 and the heat transfer blocks 600 to the outside when heat is generated from the PTC elements 500. The passages cause spaces, which are defined by pairs of the first and second supporting members 422 and 424 adjacent to each other in the longitudinal direction of the insulator 400, to communicate with the outside. That is, gas generated in the spaces defined by the first and second supporting members 422 and 424 is discharged to the outside via the passages 446 and 448 provided at the first and second supporting members 422 and 424 and the passages 442 and 444 of the enlarged portions 432 and 434. With the above structure, deformation of the coupling members 410 due to the gas can accordingly be prevented.

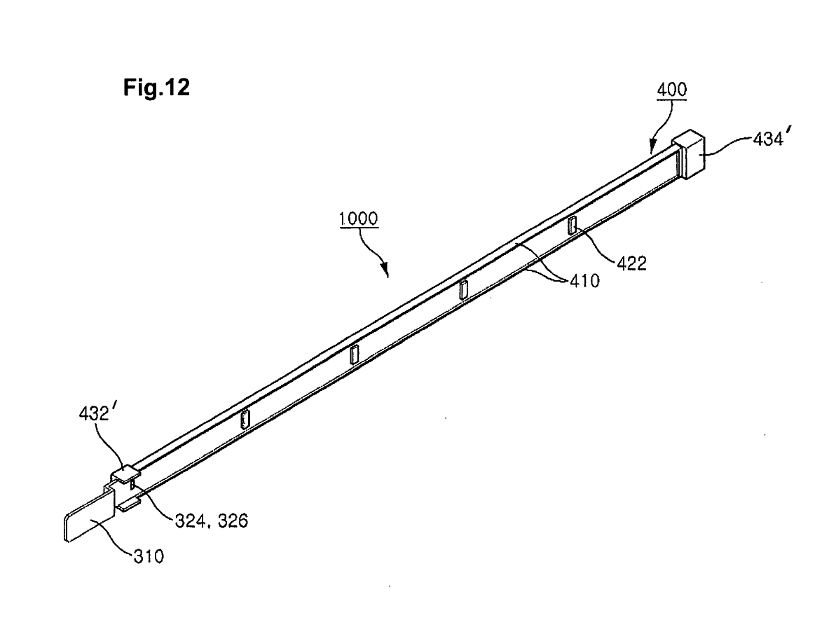

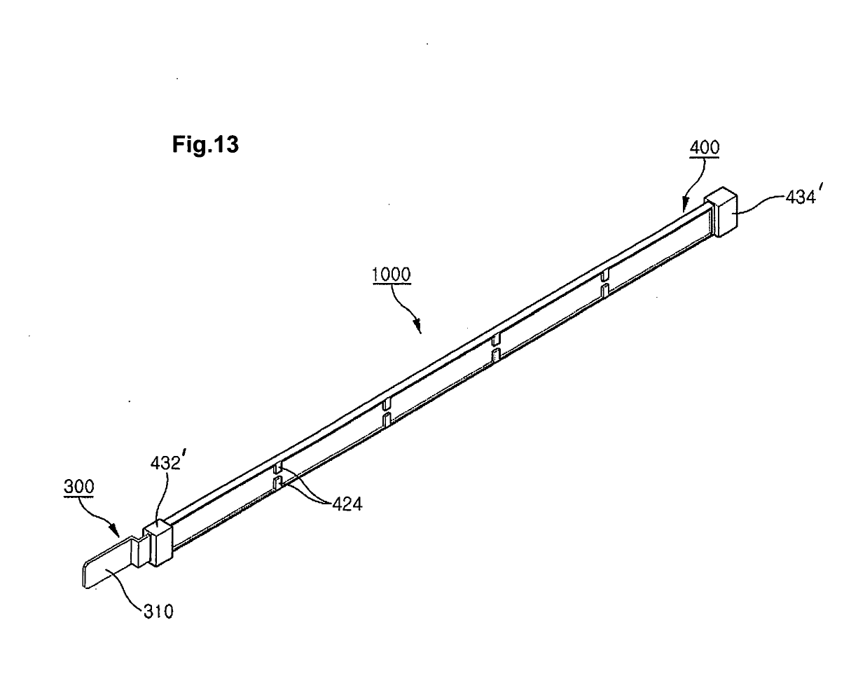

FIG. 11 illustrates in exploded view a PTC rod assembly according to a second embodiment of the present invention, with FIG. 12 showing one side surface of a combination of an electrode terminal and an insulator included in the second embodiment, and FIG. 13 showing the other side surface of the combination of the electrode terminal and the insulator included in the second embodiment.

As shown in FIGS. 11 to 13, a PTC rod assembly 1000 according to the second embodiment of the present invention comprises a first PTC rod 100 constructed in the form of a channel in cross section and having a predetermined length, and a second PTC rod 200 having the same length as the first PTC rod 100 and coupled to the first PTC rod 100 so as to cover an open portion of the first PTC rod, an electrode terminal 300, an insulator 400, PTC rod elements 500 and heat transfer blocks 600.

The structure of the PTC rod assembly according to the second embodiment is identical with that of the PTC rod assembly according to the above described first embodiment, except that the shape of the enlarged portions 432′ and 434′ formed at both longitudinal ends of the insulator 400 in the second embodiment is different from that in the first embodiment. Accordingly, in the description of the second embodiment, only the enlarged portions of the insulator that differ from that in the first embodiment will be described.

The insulator 400 comprises a pair of coupling members 410 longitudinally coupled to upper and lower ends of the electrode terminal 300, and first and second supporting members 422 and 424 placed at locations on both surfaces of the electrode terminal 300 where the pairs of through-holes 320 are formed. The first and second supporting members 422 and 424 are connected to each other through the pair of through-holes 320. Further, enlarged portions 432′ and 434′ are formed at the both longitudinal ends of the insulator 400, respectively, and the insulator 400 is coupled to the electrode terminal 300 through a dual injection molding process.

Among the enlarged portions 432′ and 434′, the first enlarged portion 432′ formed close to the terminal 310 of the electrode terminal 300 is formed to have an open face through which one side surface of the terminal electrode 300 is exposed. A fixing hole 324 is formed at a portion of the electrode terminal 300 corresponding to the first enlarged portion 432′, and a fixing protrusion 326 is formed on one surface of the first enlarged portion 432′ corresponding to the fixing hole so that the fixing protrusion can pass through the fixing hole 324. The fixing protrusion 326 is introduced into and engaged in the fixing hole 324 so that the first enlarged portion 432′ and the electrode terminal 300 can be coupled to each other.

The second enlarged portion 434′ formed at the other side opposite to the first enlarged portion 432′ is formed to have the same cross-sectional shape as the coupled first and second PTC rods 100 and 200. Accordingly, since rear ends of the first PTC rod 100 and the second PTC rod 200 are hermetically sealed by the second enlarged portion 434′, it is possible to prevent a fire that may occur due to introduction of dust or other foreign substances through a rear end of the PTC rod assembly 1000 and subsequent contact thereof with the PTC elements 500.

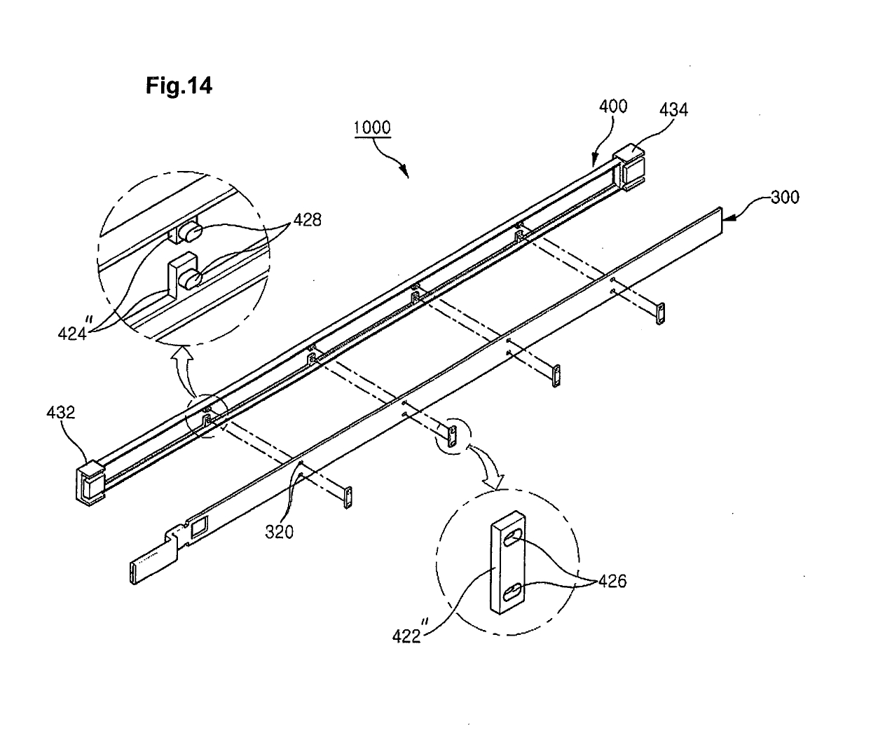

FIG. 14 is an exploded perspective view showing an electrode terminal and an insulator of a PTC rod assembly according to a third embodiment of the present invention.

As shown in FIG. 14, in the PTC rod assembly 1000 according to a third embodiment of the present invention, each of the first supporting members 422″ is detachably coupled to second supporting members 424″ of an insulator 400 so that an electrode terminal 300 can be assembled with the insulator 400. In this embodiment, each of the first supporting members 422″ is formed with coupling holes 426 corresponding to through-holes 320 of the electrode terminal 300, and each of the second supporting members 424″ is formed with a coupling protrusion 428 that passes through the through-hole 320 and is engaged in the coupling hole 426. In this embodiment, although the coupling hole 426 is formed in the first supporting member 422″ and the coupling protrusion 428 is formed in the second supporting member 424″ in this embodiment, the locations where the coupling hole 426 and the coupling protrusion 428 are formed may be interchanged with each other according to user's selection.

If the first and second supporting members 422″, 424″ are detachably coupled to each other as described above, the electrode terminal 300 and the insulator 400 can be manufactured separately. Further, since a coupling state between the insulator 400 and the electrode terminal 300 can be released without damaging the insulator 400, there is an advantage in that maintenance thereof can be easily performed.

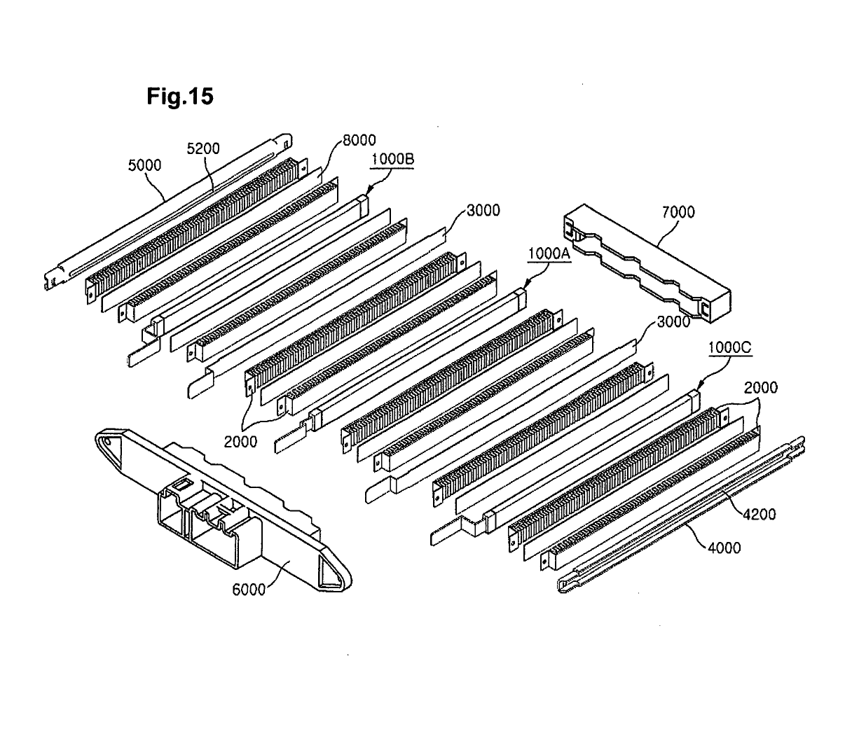

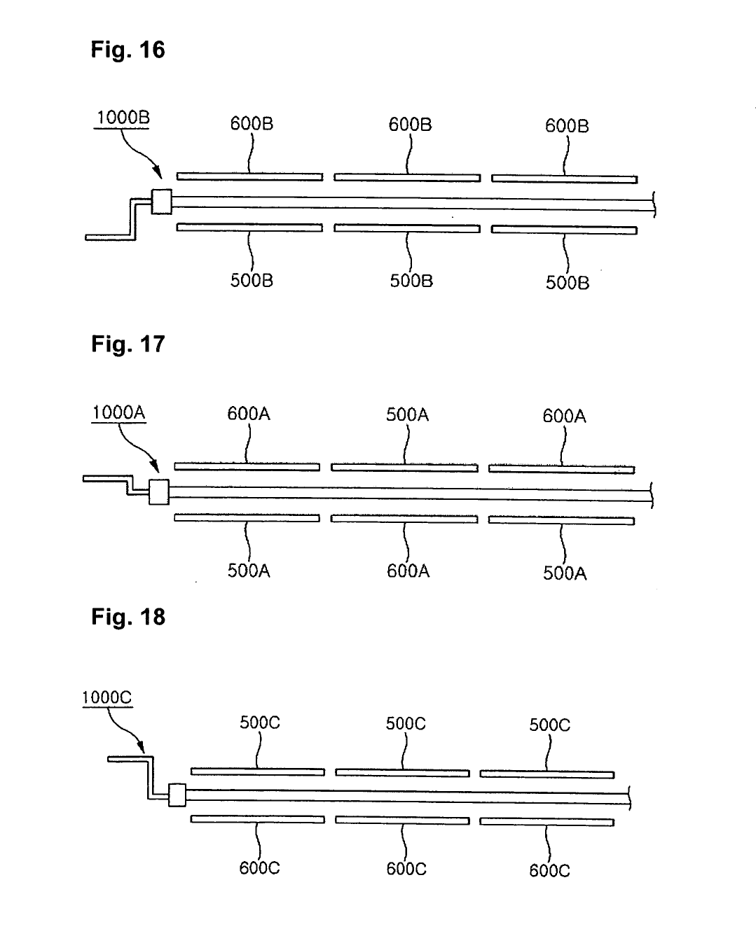

FIG. 15 illustrates in exploded view a pre-heater for a vehicle according to the present invention, and FIGS. 16 to 18 are exploded views showing the coupling positions of PTC elements and heat transfer blocks in respective PTC rod assemblies included in the pre-heater for a vehicle according to the present invention.

As shown in FIG. 15, the pre-heater for a vehicle according to the present invention comprises a plurality of PTC rod assemblies 1000A to 1000C disposed in parallel to one another in a longitudinal direction; heat radiation fin assemblies 2000 brought into contact with and coupled to both sides of each of the PTC rod assemblies 1000A to 1000C; cathode terminals 3000 each of which is placed between adjacent heat radiation fin assemblies 2000; a pair of frames 4000 and 5000 coupled to outer side surfaces of the outermost heat radiation fin assemblies 2000, respectively; and a first housing 6000 and a second housing 7000 coupled respectively to both longitudinal ends of a combination of the PTC rod assemblies 1000A to 1000C, the heat radiation fin assemblies 2000, the cathode terminals 3000 and the frames 4000 and 5000.

In this pre-heater, heat generated from PTC elements (500 in FIG. 3) installed within the PTC rod assemblies 1000A to 1000C is transferred to the heat radiation fin assemblies 2000 so as to heat air that passes through the heat radiation fin assemblies 2000.

If the pre-heater for a vehicle is constructed such that heat generated from the PTC elements (500 in FIG. 3) is not transferred to the outside but is transferred to only the heat radiation fin assemblies 2000 disposed inside, the efficiency of the pre-heater can be improved. Accordingly, as shown in FIG. 17, PTC elements 500A and heat transfer blocks 600A are mounted alternately on both surfaces of the PTC rod assembly 1000A located at a middle position so that heat can be uniformly transferred in both lateral directions. In addition, as shown in FIGS. 16 and 18, PTC elements 500B and 500C are mounted on surfaces of the PTC rod assemblies 1000B and 1000C which face the interior of the pre-heater, and heat transfer blocks 600B and 600C are mounted on surfaces of the PTC rod assemblies 1000B and 1000C which face the exterior of the pre-heater of a vehicle.

In order to prevent heat from being radiated to the outside through the housings 6000 and 7000, it is preferred that the PTC elements 5000A to 500C be spaced certain distances from the housings 6000 and 7000.

It should be understood, however, that the coupling positions of the PTC elements 500A to 500C and the heat transfer blocks 600A to 600C are not limited as shown in FIGS. 16-18, and that they may be changed optionally according to user's selection.

Reinforcing grooves 4200 and 5200 may be advantageously formed longitudinally on contact surfaces of the frames 4000 and 5000 and the heat radiation fin assemblies 2000 to minimize a contact area between each of the frames 4000 and 5000 and the corresponding heat radiation fin assembly 2000, and thereby prevent heat transferred to the heat radiation fin assemblies 2000 from being transferred to the outside through the frames 4000 and 5000. When the reinforcing grooves 4200 and 5200 are formed as described above, the contact area between each of the frames 4000 and 5000 and the corresponding heat radiation fin assembly 2000 is reduced, resulting in a lowered heat transfer rate. Further, since the interiors of the reinforcing grooves 4200 and 5200 are filled with air, some of heat in the heat radiation fin assemblies 2000 is transferred to the frames 4000 and 5000 through the air, but since air has a very low heat transfer rate, the amount of heat transferred through air can be regarded as a negligible quantity.

The PTC rod assemblies 1000A to 1000C and the heat radiation fin assemblies 2000 heated by heat generated from the PTC elements are increased in volume and then push outward on the frames 4000 and 5000 coupled to both lateral outer sides of the combination thereof. As a result, the frames 4000 and 5000 (of which the longitudinal ends are coupled to the housings 6000 and 7000) could bulge outward at intermediate portions thereof. If the frames 4000 and 5000 are bulged, there is a problem in that the coupling state of respective components disposed between the frames 4000 and 5000 may be strayed. Accordingly, the frames 4000 and 5000 may be advantageously formed such that intermediate portions of the surfaces thereof brought into contact with the heat radiation fin assemblies 2000 slantly protrude toward the corresponding heat radiation fin assemblies 2000. As compared with a conventional straight frame, the frames 4000 and 5000 of which the intermediate portions slantly protrude inward are much less bulged even though they are subjected to pressure resulting from expansion of the PTC rod assemblies 1000A to 10000C and the heat radiation fin assemblies 2000. Further, since the reinforcing grooves 4200 and 5200 serve as ribs for preventing the bulging in the frames 4000 and 5000, there is an advantage in that the frames hardly undergo deformation in shape due to an external force.

Moreover, although the additional cathode terminals 3000 are provided between the heat radiation fin assemblies 2000 in this embodiment, the frames 4000 and 5000 may be constructed to perform the function of a cathode terminal 3000 without the cathode terminal 3000. When the frames 4000 and 5000 serve as cathode terminals 3000, there are advantages in that the inner structure of the pre-heater for a vehicle is simplified and production costs can be reduced.

The heat radiation fin assemblies 2000 are coupled to both side surfaces of each of the PTC rod assemblies 1000A to 1000C. Since the amount of heat generated from one side of the PTC rod assembly where the PTC elements are mounted is higher than the amount of heat generated from the other side of the PTC rod assembly where the heat transfer blocks are mounted, a plurality of heat radiation fin assemblies 2000 are stacked laterally at the side of the PTC rod assembly where the PTC elements are mounted, and heat radiation fin assemblies 2000 of which the number is smaller than the number of the heat radiation fin assemblies 2000 coupled to the side of the PTC rod assembly where the PTC elements are mounted are coupled to the other side of the PTC rod assembly where a PTC element is not mounted. In this embodiment, two heat radiation fin assemblies 2000 are coupled to one side of the PTC rod assembly where the PTC elements are mounted and one heat radiation fin assembly 2000 is coupled to the other side of the PTC rod assembly where the heat transfer blocks are mounted. However, the number of heat radiation fin assemblies 2000 to be coupled to a side of each of the PTC rod assemblies 1000A to 1000C is not limited thereto but may be changed variously according to user's selection.

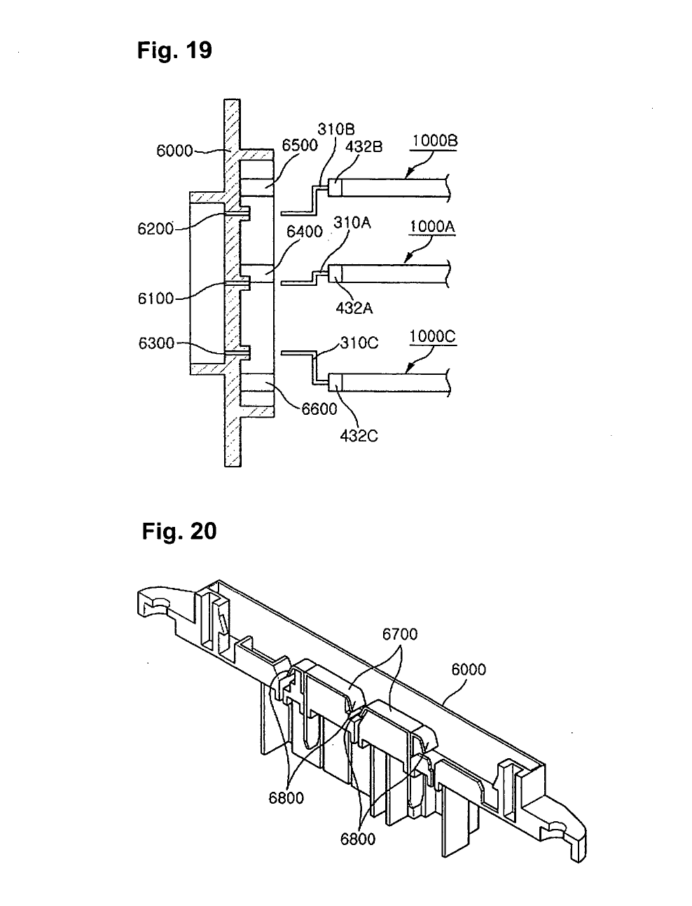

FIG. 19 illustrates coupling of a first housing and the PTC rod assemblies included in the pre-heater for a vehicle according to the present invention.

The respective PTC rod assemblies 1000A to 1000C of the pre-heater for a vehicle according to the present invention have different locations of the PTC elements and the heat transfer blocks therein. Thus, if the PTC rod assemblies are coupled to the first housing 6000 at different positions, there are several problems in that the efficiency of the pre-heater is lowered or the pre-heater is out of order. In order to avoid these problems, the PTC rod assemblies 1000A to 1000C are formed such that the lengths of bent portions of the terminals 310A to 310C thereof differ from one another. Accordingly, in the first housing 6000, the distance between each of coupling terminals 6100 to 6300 to which the terminals 310A to 310C are to be coupled and each of seating recesses 6400 to 6600 for receiving enlarged portions 432A to 432C is determined to conform to the length of the bent portion of each of the terminals 310A to 310C. Accordingly, each of the PTC rod assemblies 1000A to 1000C can be coupled at only a designated position, thereby avoiding the occurrence of a confusion in assembling the PTC rod assemblies 1000A to 1000C.

Each of the PTC rod assemblies 1000A to 1000C is coupled in such a manner that each of the enlarged portions 432A to 432C is completely inserted into the housing 6000.

Since the pre-heater for a vehicle comprising the PTC rod assembly may be identical to a conventional pre-heater in view of their basic operations except that respective components thereof are different from each other in structure, a detailed description of the basic operation thereof will be omitted.

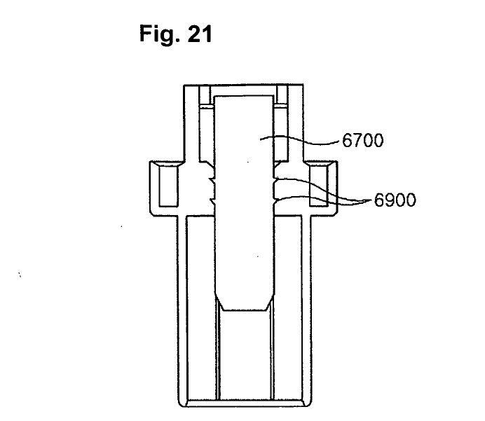

FIG. 20 illustrates a housing which may be employed in the pre-heater according to the present invention, with FIG. 21 being a sectional view of the housing, showing a coupling structure of one of housing terminals.

As shown in FIGS. 20-21, the first housing 6000 employed in the present invention includes housing terminals 6700 each of which is embedded in the first housing 6000 and which has bent plates 6800 to be brought into contact with one end of the first PTC rod 100 or the second PTC rod 200 introduced into the first housing 6000. When the housing terminals 6700 are brought into contact with the first and second PTC rods 100 and 200, the entire first and second PTC rods 100 and 200 serve as cathode terminals, and thus, there is an advantage in that it is not necessary to provide an additional cathode terminal.

Further, a portion of each of the housing terminals 6700, which is embedded in the first housing 6000, is formed with locking protrusions 6900 to be caught in the first housing 6000 so that the housing terminal 6700 cannot come out from the housing 6000. Each of the locking protrusions 6900 may be advantageously formed to have a pointed tip and to be inclined in a direction in which the housing terminal 6700 is withdrawn.

As described above, in the PTC rod assembly according to the present invention, a coupling force between the electrode terminal and the insulator can be increased by forming the electrode terminal integrally with the insulator through a dual injection molding process.

Moreover, there are advantages in that it is possible to clearly define the coupling positions of the PTC elements and the heat transfer blocks by providing the supporting members on the insulator, gas generated at the time of heating of the PTC elements can be discharged to the outside by forming the passages in the enlarged portions and supporting members of the insulator, and accordingly, it is possible to remove noise generated in a case where gas is discharged through a gap between an insulator and an electrode terminal in the prior art.

Further, the pre-heater for a vehicle according to the present invention has advantages in that heat generated from the PTC elements is not transferred to the outside but is uniformly transferred to the interior of the pre-heater, coupling forces of the respective components placed between the frames are increased, and close contact between the PTC rod assembly and the heat radiation fin assembly are improved.

Although the construction and coupling structure of the PTC rod assembly and the pre-heater for a vehicle including the same according the preferred embodiments of the present invention have been described above with reference to the drawings, they are only for illustrative purposes. It should be understood by those skilled in the art that various changes and modifications can be made thereto without departing from the scope of the present invention. Moreover, still other aspects, objects, and advantages of the present invention can be obtained from a study of the specification, the drawings, and the appended claims. It should further be understood that the present invention could be used in alternate forms where less than all of the objects and advantages of the present invention and preferred embodiment as described above would be obtained.

1. A positive temperature coefficient (PTC) rod assembly, comprising:
an electrode terminal having a plurality of pairs of through-holes at a predetermined interval in a longitudinal direction, the through-holes of each pair being spaced apart vertically from each other;
an insulator including a pair of coupling members longitudinally coupled to upper and lower ends of the electrode terminal;
first and second supporting members on both surfaces of the electrode terminal at the pairs of through-holes, the first and second supporting members being connected to each other through the through-holes;
PTC elements and heat transfer blocks coupled between adjacent pairs of said first supporting members and between adjacent pairs of said second supporting members, respectively, and in contact with the electrode terminal;
a first PTC rod defining a channel with a predetermined length to accommodate the electrode terminal, the insulator, the PTC elements and the heat transfer blocks; and
a second PTC rod having a length identical with that of the first PTC rod and coupled to the first PTC rod to cover an open portion of the first PTC rod.

2. The PTC rod assembly of claim 1, wherein the insulator has enlarged portions formed at both ends thereof in close contact with and coupled to outer surfaces of both longitudinal ends of each of the first and second PTC rods.

3. The PTC rod assembly of claim 2, wherein at least one of the enlarged portions has an open face through which one side surface of the electrode terminal is exposed.

4. The PTC rod assembly of claim 3, wherein the electrode terminal has a fixing hole contacting said at least one enlarged portion, and the enlarged portion has a fixing protrusion passing through the fixing hole.

5. The PTC rod assembly of claim 2, wherein one of the pair of enlarged portions has a passage.

6. The PTC rod assembly of claim 1, wherein the insulator is formed integrally with the electrode terminal through a dual injection molding process.

7. The PTC rod assembly of claim 1, wherein the insulator is coupled to the electrode terminal by detachable coupling structures of the first and second supporting members.

8. The PTC rod assembly of claim 1, wherein the pair of coupling members include a step whereby the width of a portion on which the PTC element is placed is different from that of a portion on which the heat transfer block is placed.

9. The PTC rod assembly of claim 8, wherein the width of the portion of the pair of coupling members on which the PTC element is placed is larger than that of the portion on which the heat transfer block is placed.

10. The PTC rod assembly of claim 1, wherein the electrode terminal has one end protruding outside of the enlarged portion and folded in two plies.

11. The PTC rod assembly of claim 10, wherein the terminal is bent in the shape of a crank.

12. The PTC rod assembly of claim 1, wherein one of the first and second supporting members has passages at both ends thereof, and the other of the first and second supporting members has a passage at an intermediate portion thereof.

13. The PTC rod assembly of claim 1, wherein the electrode terminal through-holes are elongated.

14. A pre-heater for a vehicle, comprising:
a plurality of PTC rod assemblies according to claim 1 and arranged in parallel to one another;
one or more heat radiation fin assemblies in close contact with both surfaces of each of the PTC rod assemblies;
a pair of frames coupled to outer side surfaces of the outermost heat radiation fin assemblies;
a first housing and a second housing coupled to both longitudinal ends of a combination of the PTC rod assemblies, the heat radiation fin assemblies and the frames; and
housing terminals provided in the housings and serving as cathode terminals.

15. The pre-heater of claim 14, wherein each of the outermost PTC rod assemblies has PTC elements mounted on a surface thereof facing the interior of the pre-heater.

16. The pre-heater of claim 14, wherein at least one of the PTC assemblies has the PTC elements and the heat transfer blocks alternatively mounted to both side surfaces thereof.

17. The pre-heater of claim 14, wherein the number of the heat radiation fin assemblies coupled to a side of each of the PTC rod assemblies where the PTC elements are mounted is larger than that of the heat radiation fin assemblies coupled to the other side of the PTC rod assembly where a PTC element is not mounted.

18. The pre-heater of claim 14, wherein each of the frames has an elongated, reinforcing groove formed on a surface thereof brought into contact with the heat radiation fin assembly in a longitudinal direction of the contact surface with the heat radiation fin assembly.

19. The pre-heater of claim 14, wherein an intermediate portion of a surface of each of said frames contacts and slantly protrudes toward the corresponding heat radiation fin assembly.

20. The pre-heater of claim 14, wherein each of the housing terminals includes a bent plate contacting one end of the PTC rod.
